(19) United States
(12) Patent Application Publication
(10) Pub. No.: US 2003/0071219 A1
(43) Pub. Date: Apr. 17, 2003

(54) Nuclear medicine diagnostic apparatus

(75) Inventors: Nobutoku Motomura, Tochigi-ken (JP); Koichi Ogawa, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 10/246,465

(22) Filed: Sep. 19, 2002

(30) Foreign Application Priority Data
Oct. 15, 2001 (JP) 2001-316320

(51) Int. Cl. G01T 1/166

(52) U.S. Cl. 250/363.05

(57) ABSTRACT

A nuclear medicine diagnostic apparatus for detecting gamma rays emitted from a radioisotope (RI) administered to a subject, to generate images showing the functions of the subject, such as metabolism. In the nuclear medical diagnostic apparatus, a detector detects the gamma rays from at least three different three-dimensional detection directions and an image processor reconstructs images from the projection data by an iterative reconstruction method.

Therefore, the apparatus can collect data which is high in spatial resolution and low in absorption and scatter. Moreover, it can shorten the data collection time and reduce the burden on the subject patient.

### CROSS-REFERENCE TO RELATED APPLICATIONS

This application claims priority under 35 U.S.C. § 119 to Japanese patent application No. P2001-316320 filed Oct. 15, 2001, the entire content of which are incorporated by reference herein.

### BACKGROUND OF THE INVENTION

The present invention relates to a nuclear medicine diagnostic apparatus which detects gamma rays emitted from a radioisotope (hereafter called “RI”) and obtains the RI distribution in a body of a patient after the medicine labelled with the RI is injected into the patient.

In order to obtain an image of the RI distribution as a tomographic image especially, the apparatus, the so-called SPECT (Single Photon Emission Computed Tomography), which has a detector 11 rotating 360 degrees around a body axis O of the patient P as shown in FIG. 1, is known widely. As the nuclear medicine diagnostic apparatus containing the SPECT collects data of the gamma rays, an operator shall consider the following points, for example: (1) setting the detector close to a measurement object Q (like a heart) in the body as much as possible in order to improve the spatial resolution and setting the detector such that absorption and scatter between the detector and the measurement object Q decrease as much as possible, and (2) collecting the data in as short a time as possible in order to reduce the burden on the patient.

Then, in order to fulfill these points, a commonly known method of setting the detector and collecting the data indicating below are used.

180 Degrees Data Collecting Method

As shown in FIG. 2, this method is that the apparatus collects the data of only the range of 180 rotation degrees near the measurement object Q. According to this method, the data collecting time is shorter than the conventional 360 degrees data collection time as shown in FIG. 1.

Automatic Proximity Data Collecting Method

As shown in FIG. 3, this method is that the apparatus has a sensor detecting the distance interval between the detector 11 and patient P and collects the data, as the interval is as small as possible. According to this method, the detector 11 is able to be close to the patient P as much as possible in each rotation angle, while the method as shown in FIG. 1 is that the detector 11 just moves along the circular orbit. (see, for example, U.S. Pat. No. 4,445,035 to Ueyama et al.)

Moreover, there are some know methods reconstructing images, such as an iterative reconstruction method, for example. (see, for example, IEEE Transactions On Medical Imaging, vol. MI-1, No. 2, pp. 113-122, L. A. SHEPP, et al., “Maximum Likelihood Reconstruction for Emission Tomography”) This reference shows that the image is reconstructed from the projection data detected from 2-dimensional direction and is hereby incorporated by reference.

However, the SPECT using these data collection methods, in order to shorten the data collection time, decrease the influence of scatter and absorption and improve spatial resolution, it is impossible to improve greatly these points. For example, in the above “180 degrees data collecting method”, the detector 11 is far from the measurement object Q in a part of its rotation as shown in FIG. 2. Moreover, in the above “automatic proximity data collecting method”, absorption and scatter between the detector 11 and the measurement object Q increases in a part of rotation angles as shown in FIG. 3. If the above “180 degrees data collecting method” and the “automatic proximity data collecting method” are combined, the bad data in a part of rotation angles is still collected and it is also impossible to improve the above points greatly.

Additionally, in the prior art, the collected data overlaps with each other as the detector 11 rotates 360 or 180 degrees around a body axis O and detects gamma rays from dozens of angles. Therefore, it normally takes some dozens of minutes to collect the data and the burden on the patient increases.

### SUMMARY OF THE INVENTION

It is an advantage of the present invention to obtain high spatial resolution data that has low absorption and scatter and shorten the data collection time further so as to decrease the burden of the patient.

In order to solve the above-mentioned problems, an aspect of the present invention involves a nuclear medicine diagnostic apparatus having a detector configured to detect gamma rays emitted from radioisotope in a patient. The apparatus is equipped with a supporting member configured to support the detector such that the detector detects the gamma rays from at least three-dimensional directions instead of 2-dimensional directions. Additionally the apparatus includes a processor, such as an image processor or central processor, which is configured to reconstruct a tomographic image from projection data that corresponds to detection of the detector and a display configured to display the tomographic image. Another aspect of the present invention involves a method for using such an apparatus that may reconstruct images from projection data, such as an iterative reconstruction method, for example. The apparatus's detector may detect the gamma rays from at least two different detection directions that are at least 90 degrees from each other.

In yet another aspect of the present invention, the apparatus may be equipped with a plurality of detectors, which has the collection time short. The detectors may be arranged along a body axis of the patient. In addition, each detector may face to a different direction and the direction may be variable. The three-dimensional detection directions may be three, six and eight, for example.

### BRIEF DESCRIPTION OF THE DRAWINGS

The accompanying drawings, which are incorporated in and constitute a part of the specification, illustrate some embodiments of the invention.

FIG. 1 is a view showing the 360 degrees data collecting method in a conventional nuclear medicine diagnostic apparatus;

FIG. 2 is a view showing the 180 degrees data collecting method in a conventional nuclear medicine diagnostic apparatus;

FIG. 3 is a view showing the automatic proximity data collecting method in the conventional nuclear medicine diagnostic apparatus;

FIG. 4 is a block diagram of a nuclear medicine diagnostic apparatus according to the first embodiment of the present invention;

FIG. 5 is an enlarged view of the detector according to the first embodiment of the present invention;

FIG. 6 is an outline view of the data collection unit according to the first embodiment of the present invention;

FIG. 7 is a front view showing an example of various data collection positions and directions of the detector according to the first embodiment of the present invention;

FIG. 8 is a block diagram of a nuclear medicine diagnostic apparatus according to the second embodiment of the present invention;

FIG. 9 is an enlarged view of the detector according to the second embodiment of the present invention;

FIG. 10 is an outline view of the data collection unit according to the second embodiment of the present invention; and

FIG. 11 is a front view showing an example of various data collection positions and directions of the detector according to the second embodiment of the present invention.

### DETAILED DESCRIPTION OF THE INVENTION

In the following, the embodiments are explained with reference to the drawings.

[First Embodiment]

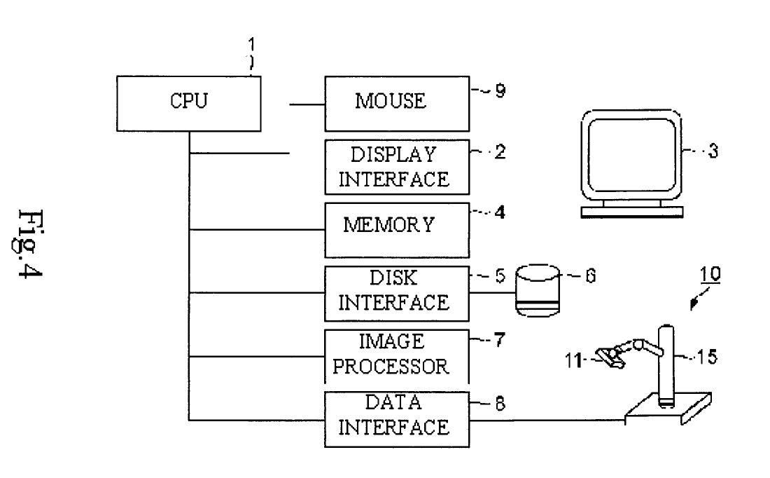

FIG. 4 is a block diagram of an exemplary nuclear medicine diagnostic apparatus according to the first embodiment. As shown in this figure, the nuclear medicine diagnostic apparatus generally has a central processing unit (CPU) 1 which controls each part of the apparatus, a display interface 2, a display 3 connected to the display interface 2, which displays images. Further, the nuclear medicine diagnostic apparatus comprises a memory 4 which stores projection data temporarily, a disk interface 5, a disk unit 6 which stores the images, an image processor which may reconstruct the images from the projection data, a data interface 8, a mouse 9 which is an example of an input device, and a data collection unit 10 which collects the projection data.

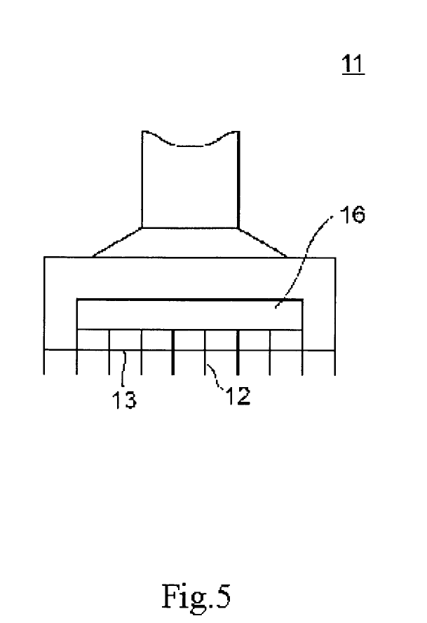

In one embodiment, the data collection unit 10 mainly has one semiconductor detector 11, which uses semiconductor material such as CdTe and CdZnTe, and a supporting member 15 which supports the detector 11. Further, as shown in FIG. 5, the semiconductor detector 11 typically has a collimator 12 which limits the direction of incidence of the gamma ray, two or more semiconductor detecting cells 13, each of which changes the gamma ray emitted from the RI in the patient into an electric signal, and a data acquisition system (DAS) 16 which collects the electric signals as the projection data.

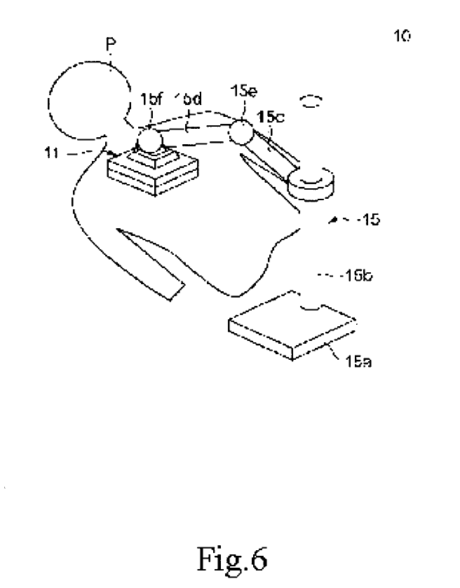

As shown in FIG. 6, the supporting member 15 of the data collection unit 10 has a base 15a put on a place near the patient P, such as a floor and a ceiling, and a pillar 15b standing on the base 15a perpendicularly. The unit 10 has a first arm 15c, joined to the pillar 15b, which can move perpendicularly. Additionally, the unit 10 has a second arm 15d that is connected to the first arm 15c via a flexible joint 15e and moves flexibly. The semiconductor detector 11 is joined to the second arm 15d via a flexible joint 15f and also moves flexibly. The position and the detecting direction of the semiconductor detector 11 can be adjusted freely in 3-dimensional space. Additionally, a sensor detecting the central position and the detecting direction of the semiconductor detector 11 may be in the flexible joint 15f.

In FIG. 4, the data interface 8 is connected with the above-mentioned data collection unit 10 and transmits the projection data detected in the data collection unit 10, the position data, and the direction data to the image processor 7. The image processor 7 reconstructs the images using the iterative reconstruction method explained below based on the projection data, the position data, and the direction data transmitted from the data interface 8. The disk interface 5 is connected with the image processor 7 and the disk unit 6 stores the reconstructed images via the disk interface 5. In addition, the disk unit 6 stores the program which is readout via the disk interface alternatively as each diagnosis according to the operation by the operator. The program can be classified into two types as the imaging method. One is making plane images from the data directly, that is to say static imaging, while the other is reconstructing tomographic images from the data. In this embodiment, reconstructing tomographic images is explained mainly.

The display interface 2 is connected with the image processor 7 and the images reconstructed by the image processor 7 are displayed on a display 3 via this display interface 2. In addition, the mouse 9 is used for selection of a predetermined function, start or stop of photography, etc. The memory 4 stores the projection data temporarily. The CPU1 controls the display interface 2, the memory 4, the disk interface 5, the disk unit 6, the image processor 7, the data interface 8, the mouse 9, etc. The above-mentioned equipment (the CPU1, the display interface 2, the memory 4, the disk interface 5, the disk unit 6, the image processor 7, the data interface 8, the mouse 9, etc.) is usually implemented as one computer system.

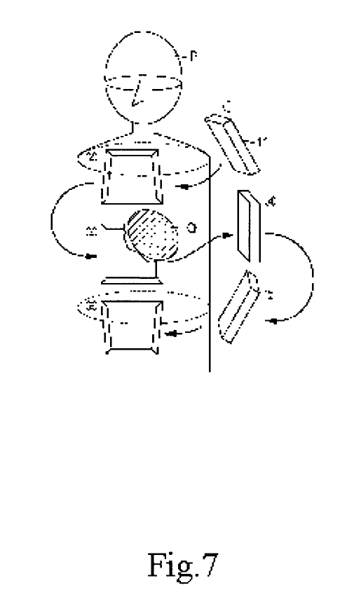

Next, the operation of the nuclear medicine diagnostic apparatus in this embodiment is explained as the case with an example myocardial examination. In this examination, the measurement object Q is mainly a left ventricle of the heart. This left ventricle (measurement object Q) is located in the upper left side part of patient P as shown in FIG. 7.

As mentioned above, in order to obtain good data (to improve the spatial resolution), it is important for the detector 11 to be as close to the measurement object Q as much as possible. As also mentioned above, it is also important for the detector 11 to be set at a suitable position where absorption and scatter between the detector 11 and the measurement object Q decreases. In this embodiment, a suitable position is near the forward left side of a patient. Specifically, it is from the left front to the left side (under the side) of the patient as shown in FIG. 7. In order to set the detector 11 at such a position, it is desirable for the detector 11 to be satisfied with the following conditions:

(1) The thickness of the detector is as thin as possible in order to set the detector at the narrow position like under the side.

(2) The “dead space” of the detector is as small as possible in order to decrease lack of the data collection view when it is close to the patient.

Therefore, it is desirable to use the detector including semiconductors, such as CdTe and CdZnTe, which fulfills these points, since the semiconductor detector is nearly smaller than the conventional detector having a collimator, a scintillator, a light guide and a plurality of photo-multipliers.

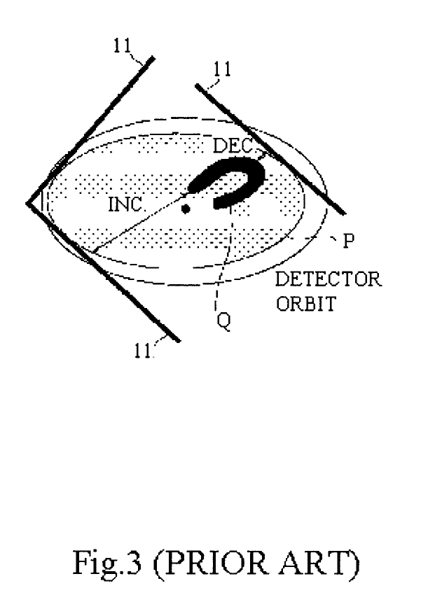

As mentioned above, in this embodiment, the data collection unit 10 is equipped with one semiconductor detector 11. As shown in FIG. 3, the detector 11 detects the gamma rays emitted from the measurement object Q from six directions at six positions (from the left-hand side under the side (1) to the left front side (6) shown in FIG. 7). In detail, according to the turn indicated by the arrow shown in FIG. 7, the detector 11 rotates around the body axis O from position (1) to (2) and it moves along the body axis O from position (2) to (3). Similarly, it rotates from position (3) to (4) and from position (5) to (6), while it moves along the body axis O from position (4) to (5). While in each position, the detecting direction of the detector 11 is selectively adjusted such that the data collection view may cover the whole measurement object Q. In other words, every pixel in the image is reconstructed from the data detected from different 3-dimensional detection directions.

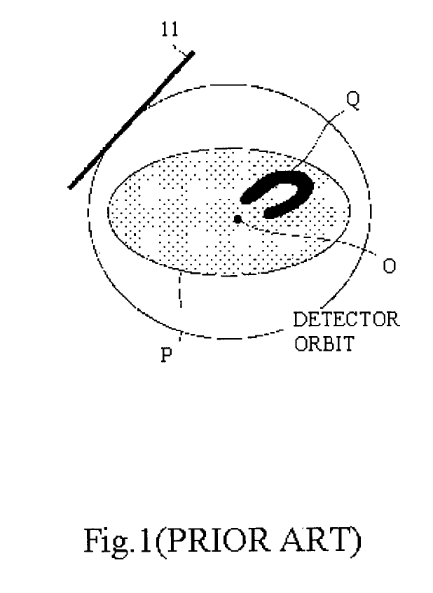

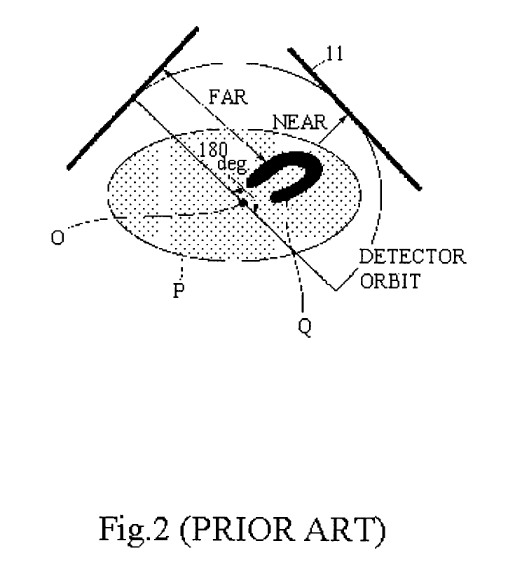

Thus, the apparatus collects the data from the different 3-dimensional detection directions and can reconstruct the image with a very few number of times (6 times data collection is indicated in this embodiment) of data collection as compared with the conventional apparatus collecting the data from 2-dimensional detection directions around the body axis (see FIGS. 1-3 examples of detection directions that vary about a 2-dimention plane). The conventional SPECT collects the data from about 60 directions (60 times) for reconstructing the image, while the present apparatus collects the data from 3-dimensional detection directions, namely at least 3 spatially different detection directions (6 directions data collection is indicated in this embodiment). Actually, the image of the same grade as the conventional SPECT was obtained using the data detected from eight directions (not shown). Therefore, the data collection time can be shortened and the burden on the patient decreased. Although the case where data is collected from six directions in six positions was explained as one example, the number of these positions and directions is not limited to this embodiment as long as the data is collected from the 3-dimensional detection directions.

The collected projection data is transmitted to the image processor 7 through the data interface 8 from the detector 11. The image processor 7 reconstructs the image by an iterative reconstruction method using the projection data transmitted from the data interface 8. The OS-EM method is one of the conventional iterative reconstruction methods known to those skilled in the art. In general the OS-EM method involves data that is divided into two or more subsets, and approximated one by one for every subset. While the number of the subsets is arbitrary, it is desirable to make one subset with two data collected at the different angle by 90 degrees from each other because the relation between the two data is otherwise small. The image data reconstructed by the image processor 7 is transmitted to the display interface 2 and displayed on the screen of the display.

[Second Embodiment]

Next, other examples of the exemplary nuclear medicine diagnostic apparatus in the first embodiment are shown and explained below as second embodiment. In this second embodiment, a data collection unit equipped with a nuclear medicine diagnostic apparatus has two or more semiconductor detectors along the patient's body axis.

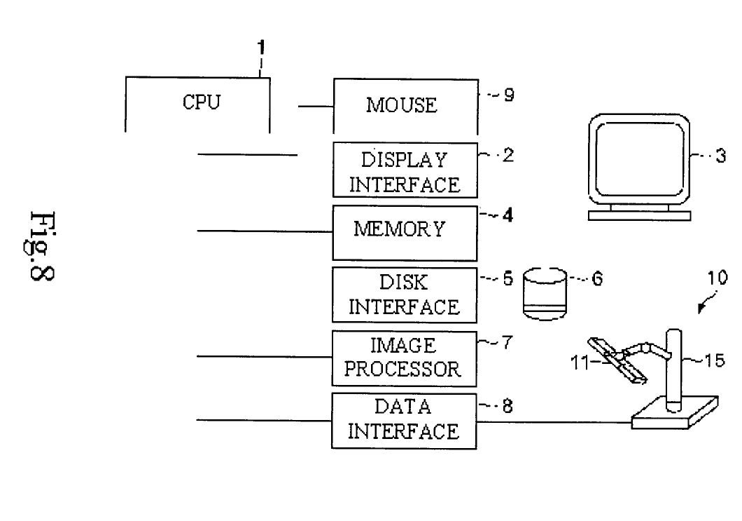

FIG. 8 is a block diagram of an example nuclear medicine diagnostic apparatus according to the second embodiment. As shown in this figure, the nuclear medicine diagnostic apparatus mainly has a central processing unit (CPU) 1 which controls each part of the apparatus, a display interface 2, a display 3, connected to the display interface 2, which displays images. Further, the nuclear medicine diagnostic apparatus comprises a memory 4 which stores projection data temporarily, a disk interface 5, a disk unit 6 which stores the images, a image processor which reconstructs the images from the projection data, a data interface 8, a mouse 9 which is an input device, and a data collection unit 10 which collects the projection data.

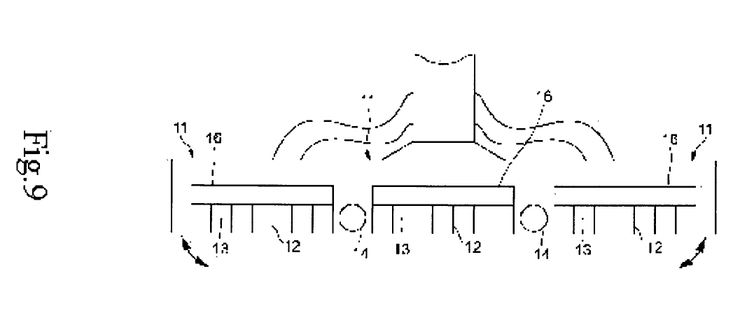

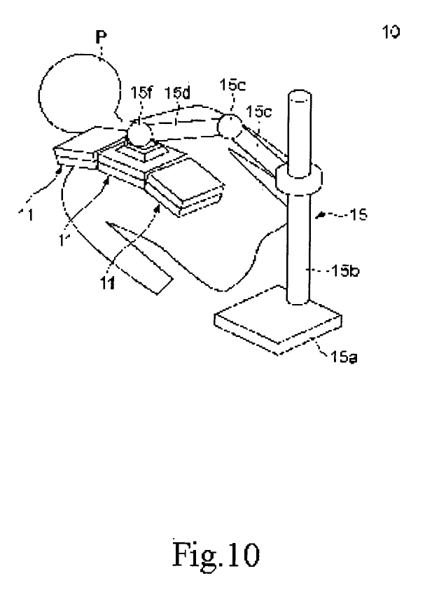

In this alternative embodiment, the data collection unit 10 mainly has three semiconductor detectors 11 which use semiconductor material such as CdTe and CdZnTe, and a supporting member 15 which supports the detector 11. Further, as shown in FIG. 9, each of the semiconductor detectors 11 typically has a collimator 12 which limits the direction of incidence of the gamma ray, two or more semiconductor detecting cells 13, each of which changes the gamma ray emitted from the RI in the patient into an electric signal, and a data acquisition system (DAS) 16 which collects the electric signals as the projection data. Furthermore, each detector 11 is arranged along the body axis and connected by the cylinder-like connection part 14. These detectors 11 can rotate about the main axis of the connection part 14 as the arrow shows in FIG. 9. As shown in FIG. 10, the supporting member 15 of the unit 10 has a base 15a put on a place near the patient P, such as a floor and a ceiling, and a pillar 15b standing on the base 15a perpendicularly. The unit 10 has a first arm 15c, joined to the pillar 15b, which can move perpendicularly. Additionally, the unit 10 has a second arm 15d that is connected to the first arm 15c via a flexible joint 15e and moves flexibly. The direction and position of the three detectors 11 are adjusted as they are hold along the body axis.

In FIG. 8, the data interface 8 is connected with the above-mentioned data collection unit 10 and transmits the projection data detected in the data collection unit 10 to the image processor 7. The image processor 7 reconstructs the images from the projection data using an iterative reconstruction method explained below based on the projection data transmitted from the data interface 8. The disk interface 5 is connected with the image processor 7 and the disk unit 6 stores the reconstructed images via the disk interface 5. In addition, the disk unit 6 stores the program which is readout via the disk interface alternatively as each diagnosis according to the operation by the operator. The program can be classified into two types as the imaging method. One is making plane images from the data directly, that is to say static imaging, while the other is reconstructing tomographic images from the data. In this second embodiment, reconstructing tomographic images is explained mainly.

The display interface 2 is connected with the image processor 7 and the images reconstructed by the image processor 7 are displayed on a display 3 via this display interface 2. In addition, the mouse 9 is used for selection of a predetermined function, start or stop of photography, etc. The memory 4 stores the projection data temporarily. The CPU1 controls the display interface 2, the memory 4, the disk interface 5, the disk unit 6, the image processor 7, the data interface 8, the mouse 9,etc. The above-mentioned equipment (the CPU1, the display interface 2, the memory 4, the disk interface 5, the disk unit 6, the image processor 7, the data interface 8, the mouse 9, etc.) is usually implemented as one computer system.

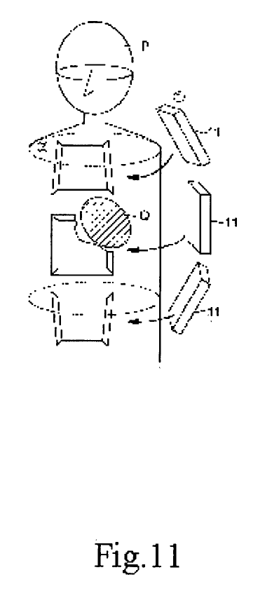

Next, the operation of the nuclear medicine diagnostic apparatus in this embodiment is explained as the case with example myocardial examination. In this examination, the measurement object Q is mainly a left ventricle of the heart. This left ventricle (measurement object Q) is located in the upper left side part of patient P as shown in FIG. 11.

As mentioned above, in order to obtain good data (to improve the spatial resolution), it is important for the detectors 11 to be as close to the measurement object Q as much as possible. As also mentioned above, it is also important for the detectors 11 to be set at a suitable position where absorption and scatter between the detectors 11 and the measurement object Q decreases. In this embodiment, a suitable position is near the forward left side of a patient. Specifically, it is from the left front to the left side (under the side) of the patient as shown in FIG. 11. In order to set the detectors 11 at such a position, it is desirable for the detectors 11 to be satisfied with the following conditions:

(1) The thickness of the detector is as thin as possible in order to set the detector at the narrow position like under the side.

(2) The “dead space” of the detector is as small as possible in order to decrease lack of the data collection view when it is close to the patient.

Therefore, it is desirable to use detectors including that include semiconductor material such as CdTe and CdZnTe, which fulfills these points, since the semiconductor detector is nearly smaller than the conventional detector having a collimator, a scintillator, a light guide and a plurality of photo-multipliers.

As mentioned above, in this second embodiment, the data collection unit 10 is equipped with three semiconductor detectors 11 which detects the gamma rays emitted from the measurement object Q from six directions at two positions (the left-hand side (1) and the left front side (6) shown in FIG. 11) Moreover, as mentioned above, each detector can rotate around the main axis of the connection part 14 and is selectively adjusted such that the data collection view may cover the whole measurement object Q in each measurement position.

Thus, the apparatus collects the data from the different 3-dimensional detection directions and can reconstruct the image with the very few number of times (6 times data collection is indicated in this embodiment) of data collection as compared with the conventional apparatus collecting the data from 2-dimensional detection directions around the body axis. Moreover, by using two or more detectors to detect the gamma rays from a plurality of different directions at the same time, the data collection time can be further shortened, as compared with the first embodiment.

In addition, in this second embodiment, although the case where the data is collected from six directions in two positions was explained as one example, the number of these positions and directions is not limited to this embodiment as long as the data is collected from the 3-dimensional detection directions.

The collected projection data is transmitted to the image processor 7 through the data interface 8 from the detector 11. The image processor 7 reconstructs the image by an iterative reconstruction method to the projection data transmitted from the data interface 8. The OS-EM method is one of the known iterative reconstruction methods. The OS-EM method involves data that is divided into two or more subsets, and approximated one by one for every subset. While the number of the subsets is arbitrary, it is desirable to make one subset with two data collected at the different angle by 90 degrees from each other because the relation between the two data is otherwise small. The image data reconstructed by the image processor 7 is transmitted to the display interface 2 and displayed on the screen of the display.

In the first and second embodiment explained above, although the detector which uses semiconductors, such as CdTe, and is compact structure is explained, the anger type detector having a collimator, a scintillator, a light guide and a plurality of photo-multipliers can also be used.

Moreover, in these embodiments, the supporting member which has a plurality of arms flexibly connected with the flexible joint is explained as one example, however another structure can be used as long as the detector can detect the gamma rays from 3-dimensional detection directions. The SPECT including the detector fixed to a rotation ring can be used, for example. Moreover, in these embodiments, it is explained that the operator moves the detector manually. However a computer may operate it automatically.

As explained above, the nuclear medicine diagnostic apparatus can collect the projection data at the position which is close and good condition, since the direction and position of the detector can be adjusted freely in the 3-dimensional space. Therefore, the data (which has a high spatial resolution and a low absorption and scatter) can be obtained, as compared with the conventional nuclear medicine diagnostic apparatus. Additionally, the time and number of the data collection can be shortened and lessened as compared with the conventional nuclear medicine diagnostic apparatus since the detector detects the gamma rays from the different 3-dimensional detection directions.

Moreover, the apparatus including two or more of these detectors can shorten the data collection time because it can detect the gamma rays emitted from the measurement object from two or more directions at the same time.

1. A nuclear medicine diagnostic apparatus comprising:
a detector configured to detect gamma rays emitted from a radioisotope in a patient;
a supporting member configured to support the detector such that the detector detects the gamma rays from at least three different three-dimensional detection directions;
a processor configured to reconstruct a tomographic image from projection data that corresponds to the detected gamma rays; and
a display configured to display the tomographic image.

2. The nuclear medicine diagnostic apparatus according to claim 1, wherein the processor reconstructs the tomographic image by an iterative reconstruction method.

3. The nuclear medicine diagnostic apparatus according to claim 2, wherein the detector detects the gamma rays from at least two of the detection directions that are at least 90 degrees from each other.

4. A nuclear medicine diagnostic apparatus comprising:
a plurality of detectors configured to detect gamma rays emitted from a radioisotope in a patient;
a supporting member configured to support the detectors such that the detectors detect the gamma rays from at least three different three-dimensional detection directions;
a processor configured to reconstruct a tomographic image from projection data that corresponds to the detected gamma rays; and
a display configured to display the tomographic image.

5. The nuclear medicine diagnostic apparatus according to claim 4, wherein the processor reconstructs the tomographic image by an iterative reconstruction method.

6. The nuclear medicine diagnostic apparatus according to claim 5, wherein the detectors detect the gamma rays from at least two of the detection directions that are at least 90 degrees from each other.

7. The nuclear medicine diagnostic apparatus according to claim 5, wherein the detectors are arranged along a body axis of the patient.

8. The nuclear medicine diagnostic apparatus according to claim 5, wherein each of the detectors are oriented differently compared to the others of the detectors so that each of the detectors faces a different detection direction.

9. The nuclear medicine diagnostic apparatus according to claim 8, wherein the orientation of the detectors is variable.

10. The nuclear medicine diagnostic apparatus according to claim 4, wherein the detectors collectively detect the gamma rays from three different directions before the processor reconstruct the tomographic image.

11. The nuclear medicine diagnostic apparatus according to claim 4, wherein the detectors collectively detect the gamma rays from six different directions before the processor reconstruct the tomographic image.

12. The nuclear medicine diagnostic apparatus according to claim 4, wherein the detectors collectively detect the gamma rays from eight different directions before the processor reconstruct the tomographic image.

13. A method of generating an image by a nuclear medicine diagnostic apparatus comprising:
detecting gamma rays emitted from a radioisotope in a patient by a detector;
setting the detector in a plurality of positions where the detector detects the gamma rays from at least three different three-dimensional detection directions;
reconstructing a tomographic image from projection data that corresponds to the detected gamma rays; and
displaying the tomographic image on a display.

14. The method of generating an image according to claim 13, wherein the tomographic image is reconstructed by an iterative reconstruction method.

15. The method of generating an image according to claim 13, wherein the detector is set such that the detector detects the gamma rays from at least two of the detection directions that are at least 90 degrees from each other.

16. A nuclear medicine diagnostic apparatus comprising:
a detector configured to detect gamma rays emitted from a radioisotope in a patient;
a supporting member configured to support the detector such that the detector detects the gamma rays from at least three different three-dimensional detection directions;
a sensor configured to detect the position and direction of the detector;
a processor configured to reconstruct a tomographic image from projection data that corresponds to the detected gamma rays, the position of the detector and the direction of the detector by an iterative reconstruction method; and
a display configured to display the tomographic image.
